(19) United States
(12) Patent Application Publication
(10) Pub. No.: US 2026/0242141 A1
(43) Pub. Date: Aug. 20, 2026

(54) Handling system comprising a carrier structure and mobile handling unit held thereon

(71) Applicant: J.Schmalz GmbH, Glatten (DE)

(72) Inventor: Matthias Frey, Sulz-Dürrenmettstetten (DE)

(21) Appl. No.: 19/539,972

(22) Filed: Feb. 13, 2026

(30) Foreign Application Priority Data
Feb. 14, 2025 (DE) 10 2025 105 581.5

(51) Int. Cl. B65G 1/137; B65G 47/90; B65G 47/91; E04B 9/18

(52) U.S. Cl. CPC B65G 1/137; B65G 47/90; B65G 47/91; E04B 9/18

(57) ABSTRACT

The invention relates to a handling system (10) comprising a carrier structure (12) which at least partially delimits a work space (22), at least one mobile handling unit (26) movable along the carrier structure for clamping and/or gripping an object arranged in the work space, wherein the mobile handling unit has at least one running component (33) with which the mobile handling unit moves along a side of the carrier structure facing the work space, and wherein the mobile handling unit has a drive device for driving the at least one running component, and a holding device for providing a holding force, in particular an attractive force, between the mobile handling unit and the carrier structure.

### CROSS-REFERENCE TO RELATED APPLICATIONS

The present application claims priority to German Patent Application 102025 105 581.5 filed February 14, 2025, which is hereby incorporated by reference in its entirety.

### FIELD OF THE DISCLOSURE

The invention relates to a handling system comprising a carrier structure and at least one mobile handling unit, which is movable relative to the carrier structure.

### BACKGROUND OF THE DISCLOSURE

Handling systems are known in various forms from the prior art and serve, among other things, to grip objects, e.g., workpieces, from a source region, e.g., an output of a production machine, and transfer them to a target region, e.g., a store.

One exemplary field of application is the automated removal of cut or punched parts from a processing machine, e.g., a laser cutting system. The difficulty here is that the parts to be gripped often have very different geometries and their dimensions and weight can also change depending on the batch. This makes it difficult to implement a standard handling process.

For example, portal solutions are known from the prior art, in which a gripping device is attached to a portal crane. Swivel crane solutions with suction gripping devices are also known. Furthermore, industrial robots are known that are equipped with a gripping device and can optionally be moved uniaxially on a rail system.

However, the known systems are only flexible to a limited extent and can often be adapted to changing requirements, for example regarding the size of the handling region, gripping performance or load capacity, only with a comparatively large amount of design effort.

The invention addresses the object of providing a handling system that overcomes the disadvantages of the prior art.

### SUMMARY OF THE DISCLOSURE

This invention is achieved by a handling system having the features described herein.

The handling system has a carrier structure, in particular in the form of a carrier plate. The carrier structure at least partially delimits a work space, in particular in the vertical direction, and more particularly at the top.

The handling system also comprises at least one, preferably more than one, mobile handling unit.

The mobile handling unit is designed to grip and/or clamp an object arranged in the work space. In particular, the mobile handling unit may have a gripping device and/or a clamping device.

The mobile handling unit is arranged on an (inner) side of the carrier structure facing the work space.

The mobile handling unit is arranged to be movable along the carrier structure, in particular in at least two, preferably at least four, different directions, and particularly preferably in any direction.

The mobile handling unit has, in particular on a side opposite the gripping device and/or clamping device, at least one running component, in particular rotatably mounted, in particular in the form of a wheel or a chain. The mobile handling unit is arranged on the carrier structure in such a way that the at least one running component rests on the (inner) side of the carrier structure facing the work space. In particular, the mobile handling unit travels with the at least one running component on the (inner) side of the carrier structure facing the work space. The mobile handling unit is in particular designed as an autonomous vehicle.

The mobile handling unit preferably also has a drive device for driving the at least one running component. The drive device can in particular have an electric motor.

The mobile handling unit is held on the carrier structure by a holding force. The holding force acts in particular in a direction orthogonal to a direction of travel of the mobile handling unit. In particular, the handling system has a holding device which is designed to provide a holding force, in particular an attractive force, acting between the mobile handling unit and the carrier structure, by means of which the mobile handling unit is held on the carrier structure.

Such a design of a handling system with a carrier structure and a plurality of mobile handling units which are arranged thereon and are flexibly movable enables particularly flexible use of the handling system. In particular, the handling system can be adapted to new handling requirements in a simple and cost-effective manner. For example, the gripping performance (usually indicated in gripping events/picks per hour) and/or the load capacity of the handling system can be easily changed by arranging more or fewer mobile handling units on the carrier structure. Because the mobile handling unit travels on at least one wheel on the carrier structure and is held by means of a holding force provided by the holding device, a large freedom of movement of the mobile handling unit is created. In particular, travel paths of the mobile handling unit are not specified by rails or other structural boundary conditions, which regularly leads to limitations in the prior art. Because the mobile handling unit is flexibly movable, so-called "swarm gripping" is also possible, meaning that a plurality of mobile handling units can jointly handle an object – for example, because the object would be too big or too heavy for a single mobile handling unit. For example, the same handling system can be used to grip entire steel plates, feed them to a processing machine, e.g., a laser cutting machine, and then handle the cut parts.

The running component can in particular have a peripheral running surface. The running component can be designed as a wheel. Alternatively, the running component can be designed as a peripheral belt or chain. Preferably, the running component is a wheel. Preferably, the running component rolls on the carrier structure with a running surface.

The handling system preferably has a source region (receiving region) arranged in the work space for receiving objects, and a target region arranged in the work space for receiving objects. Then the mobile handling unit can in each case be designed to transfer objects from the source region to the target region. The source region can, for example, be an output of a processing machine. The source region can also be a storage location. The target region can, for example, be a storage location.

The source region and/or the target region can each have a deposition location, in particular a receiving region, for objects. The deposition location can be, for example, a container, e.g., a receiving box, or a plate, e.g., a table. In the context of an advantageous development, a distance between the deposition location of the source region and/or the deposition location of the target region and the carrier structure can be changed. This makes it possible, for example, to move the deposition location closer to the mobile handling unit when dealing with sensitive or particularly heavy objects, in order to reduce the drop height when depositing the object. In particular, the deposition location of the source region and/or the deposition location of the target region can be designed to be vertically adjustable. Additionally or alternatively, it is also conceivable that a receiving region of the carrier structure arranged above the source region, and/or a deposition region of the carrier structure arranged above the target region, is designed to be adjustable along the vertical direction.

The holding force can be provided, at least partially, by a magnetic force. In this respect, the holding device can be designed to generate a magnetic force acting between the mobile handling unit and the carrier structure.

Alternatively or additionally, the holding force can be provided at least partially by a suction force. In this respect, the holding device can be designed to generate a suction force acting between the mobile handling unit and the carrier structure. For example, the mobile handling unit can have one or more suction devices, which are designed to suction the carrier structure and thus generate a holding force.

Alternatively or additionally, the holding force can be provided at least partially by an adhesive force. In this respect, the holding device can be designed to provide an adhesive force acting between the mobile handling unit and the carrier structure. In particular, the mobile handling unit can have an adhesion structure, in particular a gecko structure.

The holding force can be provided by just one of magnetic force, suction force and adhesive force. The holding force can also be provided by a combination of magnetic force, suction force and adhesive force. Preferably, the holding force is a magnetic force.

The holding force is particularly greater than a weight force of the mobile handling unit. In particular, the holding force is greater than the sum of the weight force of a mobile handling unit, a maximum load capacity of the mobile handling unit and optionally a safety factor. In an arrangement where the mobile handling unit hangs downwards from the carrier structure, it can be ensured, in this respect, that the handling unit, in particular also with an object held thereon, does not fall down. The holding force can in particular counteract gravity.

The holding device has in particular at least one first holding component and at least one second holding component, the holding force being provided by the interaction of the first holding component with the second holding component. For example, the at least one first holding component or the at least one second holding component can comprise a permanent magnetic material, and the other holding component can comprise a magnetizable, i.e., magnetically polarizable, material, in particular steel. A magnetic force can then be provided through the interaction of the first holding component and the second holding component.

The at least one first holding component is provided on the handling unit (handling unit-side holding components). Preferably, the at least one first holding component is formed by the running component (or at least one of the running components) of the mobile handling unit or is arranged on the running component (or on at least one of the running components) of the mobile handling unit. The at least one second holding component is provided on the carrier structure (carrier structure-side holding component). The at least one second holding component can be provided separately from the carrier structure and, in particular, can be attached to the carrier structure. Preferably, the at least one second holding component is provided by the carrier structure itself.

In particular, the holding force acts between the carrier structure and the at least one running component of the mobile handling unit. In this way, a reliable holding force is provided. In addition, such a design facilitates efficient and, in particular, rapid relocation of the mobile handling unit. This, in conjunction with the freedom of movement described above, makes it possible to handle objects of different sizes and geometries quickly and cost-effectively in a simple way.

In the context of an advantageous embodiment, the running component of the mobile handling unit, or at least one of the running components of the mobile handling unit, is designed as a traction wheel which adheres to the carrier structure by means of magnetic force, suction force and/or adhesive force.

In the context of a first advantageous implementation, the carrier structure can comprise a permanent magnetic, in particular ferromagnetic, material, and in particular be made of it, and the running component or at least one of the running components of the mobile handling unit can comprise a magnetizable, i.e., magnetically polarizable, material, in particular steel, and in particular be made of it. In particular, the carrier structure can be designed as a plate made of a permanent magnetic material (magnetic plate or magnetic board). Alternatively, the carrier structure can comprise a plate and a plurality of magnetic elements which are arranged on the plate and are made of a permanent magnetic material, in particular the magnetic elements being distributed over the plate. The plate can then be made of a non-magnetic material. In particular, the running component or at least one of the running components, in particular all the running components, of the mobile handling unit can be designed as a steel wheel (i.e., as a wheel which is made of steel at least in portions).

In the context of a second, preferred implementation, the running component or at least one of the running components of the mobile handling unit can comprise a permanent magnetic, in particular ferromagnetic, material, and in particular be made of it, and the carrier structure can comprise a magnetizable material, in particular steel, and in particular be made of it.

It is particularly advantageous if the running component or at least one of the running components of the mobile handling unit is designed as a magnetic traction wheel (also referred to as a permanent magnetic traction wheel or magnetic wheel). Such magnetic traction wheels are available, for example, from thyssenkrupp Magnettechnik or Tridelta Magnetsysteme GmbH.

In such an embodiment with magnetic wheels on the mobile handling unit, the carrier structure can then be designed in particular as a plate made of a magnetizable material, preferably as a metal plate, more preferably as a steel plate. However, this does not rule out the possibility that the plate may have a non-magnetically magnetizable coating, e.g., a plastics coating or similar. Alternatively, the carrier structure can consist of a plate and a plurality of metal elements arranged on the plate. Preferably, the metal elements are then arranged distributed across the plate. The plate can then be made of a non-magnetic material.

It proves advantageous if the mobile handling unit has at least two driven magnetic wheels. In this way, particularly high accelerations can be achieved without impairing a holding force, which in turn has a positive effect on the gripping performance (pick rate) of the handling system.

Furthermore, it proves advantageous if the mobile handling unit has at least one non-driven(passive) magnetic wheel. The non-driven magnetic wheel can be designed to steer the mobile handling unit. For example, the non-driven magnetic wheel can be arranged on the mobile handing unit so as to be pivotable about a pivot axis that is orthogonal to the wheel axis.

In the context of a further aspect, the running component or at least one of the running components, in particular all the running components, of the mobile handling unit can have a plurality of suction cups. In particular, the running component can be designed as a suction wheel comprising a plurality of suction cups. In the case of such an embodiment, a suction force can then be provided via the suction cups (upon contact with the carrier structure). One exemplary implementation of a suction wheel can have a carrier wheel, on the peripheral surface of which a plurality of suction cups are arranged. In an embodiment with suction cups, in particular a suction wheel, the at least one first holding component is then provided in particular by the suction cups, and the second holding component is provided by the carrier structure itself. The suction cups can be actively subjected to negative pressure. For example, it is conceivable that the mobile handling unit has a negative pressure generation device for generating negative pressure. The suction cups can also be designed as passive suction cups. In this respect, a negative pressure can be generated only by contact with the carrier structure through deformation of the suction cup.

In particular, a handling system is also proposed, comprising a carrier structure, in particular a carrier plate, which at least partially delimits a work space, at least one, preferably more than one, mobile handling unit, which is movable along the carrier structure, in particular in any direction, for clamping and/or gripping an object arranged in the work space, the mobile handling unit having at least one running component, in particular a suction wheel, comprising a plurality of suction cups, the mobile handling unit with the running component, in particular the suction wheel, moving along a side of the carrier structure facing the work space in such a way that the suction cups exert a suction force, in particular one that at least partially compensates a weight force of the mobile handling unit.

In the context of a further aspect, the running component or at least one of the running components, in particular all the running components, of the mobile handling unit can have an adhesion structure, in particular a gecko structure. In particular, the running component can be designed as an adhesion wheel which has an adhesion structure, in particular a gecko structure, on a running surface. Such an adhesion structure can then provide an adhesive force in contact with the carrier structure. For example, the adhesion wheel can have a carrier wheel on the peripheral surface of which an adhesion structure, in particular a gecko structure, is arranged. In an embodiment with an adhesion structure, in particular an adhesion wheel, the at least one first holding component is then provided in particular by the adhesion structure, and the second holding component is provided by the carrier structure itself.

In particular, a handling system is also proposed, comprising a carrier structure, in particular a carrier plate, which at least partially delimits a work space, at least one, preferably more than one, mobile handling unit, which is movable along the carrier structure, in particular in any direction, for clamping and/or gripping an object arranged in the work space, the mobile handling unit having at least one running component, in particular adhesion wheel, comprising an adhesion structure, in particular gecko structure, the mobile handling unit with the adhesion structure being in contact with a side of the carrier structure facing the work space, such that an adhesive force acting between the handling unit and the carrier structure is provided.

In the context of an advantageous development, the holding device, in particular the mobile handling unit, can, more particularly in addition to an embodiment of the at least one running component as a traction wheel (magnetic wheel, suction wheel or adhesion wheel), have a suction device formed separately from the at least one running component, in particular a suction plate or Bernoulli suction device. The suction device is in particular designed to suction the carrier structure and thus provide an attractive force between the mobile handling unit and the carrier structure. In this respect, the attractive force provided by the suction device can contribute to the holding force provided by the holding device.

Furthermore, it may prove advantageous if the handling system has, in addition to the holding device, a securing device that is designed to secure the mobile handling unit against falling, at least at selected positions along the carrier structure, in particular to fix it on the carrier structure. In this respect, the securing device can provide additional protection against the handling unit detaching from the carrier structure. This can be advantageous in particular if the carrier structure delimits the work space at the top and the handling unit hangs downwards from the carrier structure. For example, special protection can be provided in the case of collaborative operation of the handling system and people. It is thus conceivable, for example, that, in the work space, safety regions are defined in which the securing device is active.

The securing device can be arranged on the mobile handling unit. For example, the handling unit can have an electromagnet or an extendable and retractable mechanical latch. It is also conceivable that the carrier structure has a securing device at selected positions (safety regions), e.g., in the form of a mechanical lock or a safety net, which prevents the handling unit from falling.

The carrier structure can be designed in different ways. Preferably, the carrier structure is designed as a carrier plate. However, the term "carrier plate" does not preclude the possibility that the carrier plate has local openings. For example, the carrier plate can be designed as a perforated metal plate. Preferably, the carrier plate has a completely closed surface. The carrier plate can also be designed as a carrier mesh. The carrier plate can be flat. The carrier plate can also be curved or wavy.

In the context of an advantageous embodiment, the carrier structure can delimit the work space at the top in the vertical direction. In this respect, the carrier structure can form a ceiling structure of the work space. Then, the at least one mobile handling unit can be arranged on an underside of the carrier structure facing the work space, and be held against falling by means of the holding force, in particular by means of magnetic force. The at least one mobile handling unit can be arranged on the carrier structure in particular so as to hang downwards, i.e., in the direction of gravity. The holding device is then designed in particular in such a way that a holding force that counteracts gravity acts between the mobile handling unit and the carrier structure, in particular between the at least one running component of the mobile handling unit and the carrier structure.

In particular, a handling system is also proposed, comprising a carrier structure, in particular carrier plate, in particular extending horizontally, which delimits a work space at the top in the vertical direction, at least one, preferably at least two, mobile handling unit for gripping and/or clamping an object arranged in the work space, the mobile handling unit being arranged on an underside of the carrier structure facing the work space and being movable along the carrier structure, in particular in any direction, the mobile handling unit having at least one running component, in particular wheel, with which it travels along the carrier structure, the mobile handling unit being held on the carrier structure, against falling, by means of a holding force, in particular a magnetic force.

The carrier structure can have one or more portions, in particular contiguous portions. Each portion can be provided by a plate, in particular a steel plate.

In some embodiments, the carrier structure, in particular carrier plate, has a ceiling portion that delimits the work space at the top in the vertical direction. The ceiling portion can extend horizontally. The ceiling portion can also extend obliquely. The mobile handling unit can then be arranged or designed to travel along the underside of the ceiling portion facing the work space.

Alternatively or additionally, the carrier structure, in particular carrier plate, can have a floor portion that delimits the work space at the bottom in the vertical direction. The floor portion can extend horizontally. The floor portion can also extend obliquely. The mobile handling unit can then be arranged or designed to travel along the upper side of the floor portion facing the work space.

Alternatively or additionally, the carrier structure, in particular carrier plate, can have a side portion that delimits the work space laterally, i.e., in the horizontal direction. The side portion can extend along the vertical. The side portion can also extend obliquely. The mobile handling unit can then be arranged or designed to travel along an (inner) side of the side portion facing the work space.

In embodiments with a ceiling portion and a side portion, it can also be advantageous if the carrier structure has an, in particular curved, ceiling transition portion which connects the ceiling portion to the side portion. This allows the mobile handling unit to move between the ceiling portion and the side portion without relocating. For example, it is conceivable that the mobile handling unit is loaded at one position along the side portion and then moved across the ceiling portion to a target region in the work space.

In embodiments with a side portion and a floor portion, it can also be advantageous if the carrier structure has an, in particular curved, floor transition portion which connects the floor portion to the side portion. This allows the mobile handling unit to move between the floor portion and the side portion without relocating.

The handling system can have one or more supports, by means of which the carrier structure is supported on a carrier, e.g., a building floor or a machine bed. Alternatively, it is also conceivable, for example, that the carrier structure is anchored to a building ceiling or a building floor.

In the context of an advantageous development, the carrier structure, in particular the ceiling portion and/or the floor portion, can be designed to be height-adjustable at least in portions, i.e., adjustable along the vertical direction. In an embodiment of the carrier structure as a carrier plate, the carrier plate can be designed to be adjustable along the vertical direction. In this respect, a height of the carrier plate can be adjusted. Such an embodiment allows an operator easy access to the at least one mobile handling unit when needed. For example, this method allows for manual loading of the mobile handling unit.

In an embodiment with a plurality of handling units, these can be designed to grip objects independently of one another. For example, small components can be gripped by a mobile handling unit alone.

Advantageously, in embodiments of the handling system with a plurality of mobile handling units, these can be designed and in particular coordinated with one another in such a way as to be able to jointly grip an object . This makes it possible, for example, to handle parts whose weight and/or dimensions are too large to be handled with a single mobile handling unit, by two or more mobile handling units jointly (so-called "swarm gripping").

As mentioned above, the mobile handling unit comprises in particular a gripping device or clamping device, preferably a gripping device. The gripping or clamping device is preferably arranged on a side of the handling unit opposite the at least one wheel.

Various gripping devices are conceivable. For example, the gripping device can be a mechanical gripping device, e.g., comprising one or more mechanically adjustable gripper fingers. The gripping device can also be a magnetic gripper. The gripping device can also be a needle gripper, in particular for handling textiles and/or carbon fibers.

Preferably, the gripping device is a surface gripper, in particular a magnetic gripper, vacuum gripper or adhesion gripper. The gripping device can be a magnetic gripper. The gripping device can be an adhesion gripper, in particular a gecko gripper.

Particularly preferably, the gripping device of at least one mobile handling unit, in particular of all the mobile handling units, is a suction gripping device with at least one suction point for suctioning an object. In this respect, the mobile handling unit can have a suction gripping device. In particular, the suction gripping device can have a plurality of suction points that can be activated individually, i.e., independently of one another.

In the context of an advantageous implementation, the suction gripping device can have a plurality of gripping units, each of which has a reciprocating piston that can be extended and retracted again along a stroke axis, and a suction cup that is coupled to the reciprocating piston in terms of movement. The reciprocating piston can be transferable from a retracted configuration into an extended configuration along the stroke axis by applying operating fluid, in particular compressed air. Preferably, the at least one gripping unit is designed such that in the retracted configuration of the reciprocating piston a negative pressure supply to the suction cup is interrupted, and in the extended configuration, a negative pressure supply is enabled. In this respect, the extension or retraction activates a gripping effect of the gripping unit. An exemplary embodiment of such a suction gripping device is described in DE 10 2023 109 048 A1 by the applicant, the disclosure content of which is hereby incorporated by reference.

In the context of an advantageous development, a mobile handling unit equipped with a suction gripping device can also have a negative pressure generation device for supplying the suction gripping device with negative pressure. The negative pressure generation device can be pneumatically or electrically operated, for example. Preferably, the negative pressure generation device is an electrically operated negative pressure generation device ("electric vacuum generator"). Such an electrical negative pressure generation device is comparatively compact and enables, in particular, autonomous negative pressure generation in the mobile handling unit. In an embodiment of the gripping device as a suction gripping device with lifting units, it can be further advantageous if the electrical negative pressure generation device is also designed to generate compressed air in order to extend the lifting units.

It is conceivable that a mobile handling unit has several gripping devices. The gripping devices can be of the same type or designed differently. For example, it is conceivable that a mobile handling unit has a suction gripping device and a magnetic gripping device.

It is conceivable that, in embodiments of the handling system with a plurality of mobile handling units, all the mobile handling units have the same type of gripping device. It is also conceivable that the mobile handling units, or at least a subset of the mobile handling units, have different gripping devices.

In the context of an advantageous development, the mobile handling unit can also have a lifting device, in particular in the form of a cable pull, scissor lift or a telescopic rod, on which the gripping device is mounted. The lifting device can in particular be designed to change a distance between the gripping device and a housing of the handling unit. Such an embodiment also makes it possible to bridge larger distances between the handling unit and the object to be gripped. For example, it is conceivable that the carrier structure forms a ceiling structure of the work space, which structure, in particular in the case of a collaborative operation involving people, may be several meters away from the floor. With such an embodiment, the use of a lifting device can make it possible to grip objects, e.g., boxes, stored on the floor of the work space, from above, by lowering the gripping device accordingly using the lifting device.

In the context of a general aspect, the mobile handling unit can have an energy storage device, in particular in the form of a battery or accumulator. Then it can be advantageous if the handling system has a charging zone in the work space for charging the energy storage device. In particular, the mobile handling unit can be designed in such a way that it can independently approach the charging zone, e.g., when the energy storage device has fallen below a predetermined storage level. The energy storage device can, for example, be designed to supply the drive device and/or the negative pressure generation device. It is in principle also conceivable that the mobile handling unit is supplied with electrical energy via the wheels and/or a power supply line.

The mobile handling unit can navigate along the carrier structure in different ways. For example, the mobile handling unit can be GPS-controlled. The mobile handling unit can also be controlled in a manner known per se, using lidar and/or vision-based navigation.

It is also conceivable that the carrier structure has a pattern which serves as a coordinate system for the mobile handling unit or marks certain regions of the carrier structure (e.g., a receiving region above the source region and/or a deposition region above the target region). If the carrier structure is designed as a metal plate, the pattern can, for example, have laser-generated markings on the plate.

The handling system can have a control device for controlling the handling system, in particular the at least one mobile handling unit. Each mobile handling unit can in turn have a sub-control device, in particular for controlling the gripping device and optionally the drive device and/or the negative pressure generation device, which sub-control device interacts with the control device of the handling system. The control device of the handling system may include a non-volatile memory device. The non-volatile memory device can contain control instructions for controlling the handling system, in particular the mobile handling unit. For example, a computer program can be stored on the memory device, which computer program is designed to calculate a preferred handling sequence using artificial intelligence, in order to perform a handling task, in particular the transfer of objects from the source region to the target region, in the shortest possible time.

It is also conceivable that the mobile handling unit is controlled autonomously. In this respect, the mobile handling unit can in each case have a handling unit control device, which is, in particular, independent of a higher-level control device of the handling system.

A method for operating a handling system as described above is also proposed. The method includes, in particular, jointly gripping an object arranged in the work space, in particular in the source region, of the handling system, by means of a plurality of mobile handling units ("swarm gripping").

According to the method, at least two mobile handling units are first moved to the object to be gripped. In particular, the at least two mobile handling units are moved to a gripping position on the carrier structure, from which the mobile handling units can grip the object, in particular by means of the gripping device. In other words, the method includes in particular controlling the mobile handling unit in such a way that it moves to a gripping position, from which it can grip the object, in particular by means of its respective gripping device. In particular, the mobile handling units can be moved into a receiving region of the carrier structure located above the source region.

In a further step, the object is gripped by means of the at least two mobile handling units, in particular by means of the gripping devices, in particular such that the object is held on the at least two mobile handling units. In particular, the gripping devices engage the object at different positions.

Subsequently, the at least two mobile handling units are moved together, in particular in a synchronized manner, along the carrier structure, in particular to a target region where the object is to be deposited. In this case, the mobile handling units are moved along the carrier structure preferably in a synchronized manner, in such a way that a distance between the mobile handling units remains constant.

Optionally, the object is then deposited at the target region.

Preferably, control instructions, in particular in the form of a computer program, are stored on the non-volatile memory device of the above-described control device of the handling system, which instructions, when executed, cause the handling system to carry out the method described above.

In particular, a computer program product is also proposed, comprising commands which, when executed on a computer, in particular a control device, of a handling system described above, cause the handling system to carry out the method described above. The computer program product is stored, in particular, on a non-volatile memory device.

### BRIEF DESCRIPTION OF THE DRAWINGS

The invention is explained in more detail below with reference to the figures, in which:

FIG. 1 is a simplified schematic side view of an exemplary embodiment of a handling system;

FIG. 2 is a simplified schematic plan view of a mobile handling unit according to FIG. 1;

FIG. 3 is a simplified schematic plan view of an exemplary embodiment of a handling system;

FIG. 4 is a simplified schematic side view of a further exemplary embodiment of a handling system;

FIGS. 5A and B, are simplified schematic views of a further exemplary embodiment of a mobile handling unit with suction wheels;

FIGS. 6A and B, are simplified schematic views of a further exemplary embodiment of a mobile handling unit with adhesion wheels; and

FIGS. 7A and B, are simplified schematic views of a further exemplary embodiment of a mobile handling unit with a chain drive.

### DETAILED DESCRIPTION OF THE DRAWINGS

In the following description and in the figures, identical reference signs are in each case used for identical or corresponding features.

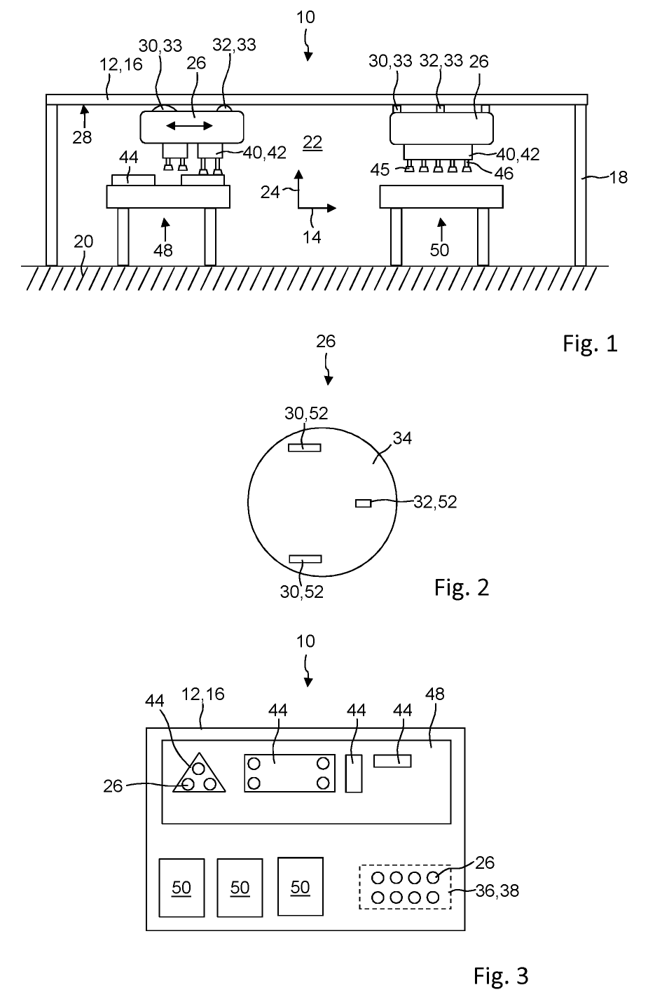

FIG. 1 shows, in a simplified schematic representation, an exemplary embodiment of a handling system, which is denoted as a whole by reference sign 10.

The handling system 10 comprises a carrier structure 12. In the example, the carrier structure 12 extends with a main extension direction in a horizontal plane (shown in FIG. 1 by the horizontal direction 14).

As can be seen from FIG. 3, the carrier structure 12 is rectangular in the example. In embodiments that are not shown, however, the carrier structure 12 can also be of any other shape, e.g., round or angular.

The carrier structure 12 is by way of example and preferably designed as a carrier plate 16. The carrier structure 12 is therefore referred to below as the carrier plate 16.

As can be seen from FIG. 1, the carrier plate 16 in the example is supported by a plurality of supports 18 on a foundation 20, e.g., a building floor or a machine bed. In embodiments that are not shown, however, the carrier plate 16 can for example also be attached to a building ceiling or otherwise.

The carrier plate 16 delimits a work space 22 of the handling system 10 at the top in the vertical direction 24 (see FIG. 1). In this respect, the carrier plate 16 forms a ceiling structure of the work space 22.

The handling system 10 also has at least two, in particular more than two, mobile handling units 26.

As can be seen in FIG. 1 (here only two mobile handling units 26 are visible), the mobile handling units 26 are arranged on an underside 28 of the carrier plate 16 facing the work space 22. The mobile handling units 26 therefore "hang" downwards from the carrier plate 16 in the direction of gravity (opposite the vertical direction 24 in FIG. 1).

The mobile handling units 26 each have three wheels 30, 32, by means of which the mobile handling units 26 travel along on the underside 28 of the carrier plate 16. The wheels 30, 32 form running components 33 of the handling unit 26. In embodiments that are not shown, the mobile handling units 26 can also have more or fewer wheels 30, 32.

In the example, the mobile handling units 26 each comprise two driven wheels 30 and one non-driven wheel 32. The non-driven wheel 32 is in particular pivotable about a pivot axis orthogonal to the wheel axis, in the example oriented parallel to the vertical direction 24 (in FIG. 2 orthogonal to the plane of the drawing).

The driven wheels 30 can be driven together or independently of one another. In particular, the driven wheels 30 can be controlled independently of one another in such a way that the wheels 30 can rotate in different directions and optionally at different speeds. In this way, a simple change of direction of a mobile handling unit 26 is made possible, so that the mobile handling units 26 can move flexibly in all directions parallel to the carrier plate 16.

Preferably, the mobile handling units 26 each comprise an electric drive device (not shown), in particular at least one electric motor, for driving the driven wheels 30. The drive device is arranged in particular in a respective housing 34 of the mobile handling units 26.

For the electrical supply of the drive device, the mobile handling units 26 can have, in particular in the housing 34, an electrical energy storage device (not shown), in particular in the form of a battery.

As indicated by way of example in FIG. 3, a parking region 36 can be defined on the carrier plate 16, in which unused mobile handling units 26 can be parked. The parking region 36 can simultaneously be a charging zone 38 for charging the electrical energy storage device of the mobile handling units 26.

As can be seen from FIG. 1, each mobile handling unit 26 has two gripping devices 40 on a side opposite the wheels 30, 32. In embodiments that are not shown, however, more or fewer gripping devices 40 can also be provided.

In the example, the gripping devices 40 are designed as suction gripping devices 42, each of which has a plurality of suction cups 45 for suctioning an object 44.

As mentioned above, the mobile handling units 26 preferably each have an electrical negative pressure generation device (not shown) for supplying the respective suction gripping device 42. The electrical negative pressure generation device can in particular be arranged in the robot housing 34. The electrical negative pressure generation device can in particular be operated by the electrical energy storage device described above.

By way of example, the suction gripping devices 42 as described above are designed having a plurality of lifting units 46, which are adjustable along a respective lifting axis (in the example parallel to the vertical direction 24) between a retracted configuration and an extended configuration, and on which a suction cup 45 is arranged in each case. One possible embodiment of such a suction gripping device 42 is described in DE 10 2023 109 048 A1 by the applicant, the disclosure content of which is hereby incorporated by reference.

As mentioned above, the work space 22 preferably includes at least one source region 48, from which objects 44 are to be transported, and at least one target region 50, to which the objects 44 are to be transported.

In the example shown in FIG. 1, the source region 48 and the target region 50 are designed as tables with corresponding deposition locations. The source region 48 can, for example, be an output of a work station. The target region 50 can, for example, be a store or a further work station. In embodiments that are not shown, the floor of the work space 22 can also form the source region and/or the target region.

As mentioned above, the mobile handling units 26 are each held on the carrier plate 16 by means of magnetic force.

In the example, this is achieved by the fact that the wheels 30, 32 are designed as magnetic traction wheels 52, i.e., they comprise a permanent magnetic material, and the carrier plate 16 is designed as a steel plate. It is also conceivable that only a subset of the wheels 30, 32, in particular only the driven wheels 30, are designed as magnetic traction wheels 52.

In embodiments that are not shown, it is also conceivable that the carrier plate 16 is designed as a magnetic board and the wheels 30, 32 are designed as steel wheels.

As indicated in FIG. 3, the mobile handling units 26 are designed to jointly grip and move an object 44. By way of example, reference is made to the object 44 shown in FIG. 3 as a triangle, which is gripped by means of three mobile handling units 26.

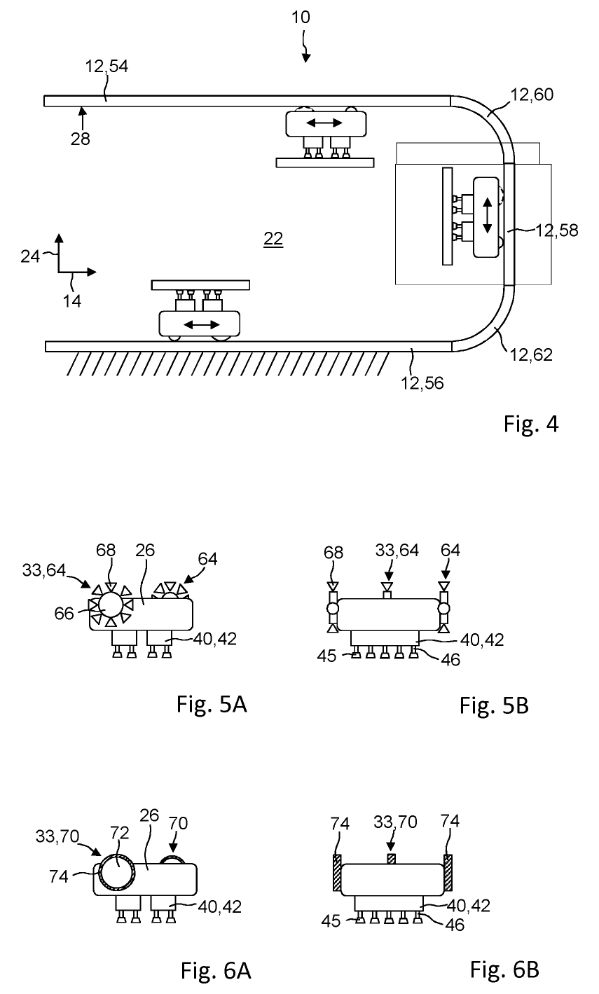

FIG. 4 shows another exemplary embodiment of a handling system 10, which differs from the handling system shown in FIG. 1 in the design of the carrier structure 12.

As can be seen from FIG. 4, the carrier structure 12 in the example has a ceiling portion 54 which delimits the work space 22 at the top in the vertical direction 24. The carrier structure 12 also has a floor portion 56, which delimits the work space at the bottom in the vertical direction 24. The carrier structure 12 also has a side portion 58, which delimits the work space 22, in the example on one side, in the horizontal direction 14.

As can be seen from FIG. 4, the carrier structure 12 also has a curved ceiling transition portion 60, which connects the ceiling portion 54 to the side portion 58. The ceiling transition portion 60 is in particular designed in such a way that a mobile handling unit 26 can travel from the ceiling portion 54 via the ceiling transition portion 60 to the side portion 58, and vice versa.

In the example, the carrier structure 12 also has a curved floor transition portion 62, which connects the side portion 58 to the floor portion 56. The floor transition portion 62 is in particular designed in such a way that a mobile handling unit 26 can travel from the side portion 58 via the floor transition portion 62 to the floor portion 56, and vice versa.

In embodiments that are not shown, it is also conceivable that the carrier structure 12 has only one or a subset of the aforementioned portions. For example, the carrier structure 12 can have only the ceiling portion 54, the ceiling transition portion 60 and the side portion 58. The carrier structure 12 can also have only the floor portion 56.

FIG. 5A and 5B show a further exemplary embodiment of a mobile handling unit 26, which has suction wheels 64 as running components 33 instead of the magnetic wheels 52. In other respects, however, the mobile handling units 26 according to FIG. 5A and 5B correspond to the handling units 26 described above with reference to FIG. 1 to 3, and therefore reference is made to the above disclosure to avoid repetition.

As can be seen from FIG. 5A, each suction wheel 64 has, by way of example, a carrier wheel 66 and a plurality of suction cups 68 arranged on a running surface of the carrier wheel 66. During operation, the suction cups 68 then rest against the carrier structure 12, in particular carrier plate 16, and thus generate a holding force (suction force) by means of which the mobile handling unit 26 is held on the carrier structure 12.

FIG. 6A and 6B show a further exemplary embodiment of a mobile handling unit 26, which has adhesion wheels 70 as running components 33 instead of the magnetic wheels 52. In other respects, however, the mobile handling units 26 according to FIG. 6A and 6B correspond to the handling units 26 described above with reference to FIG. 1 to 3, and therefore reference is made to the above disclosure in order to avoid repetition.

As can be seen from FIG. 6A, each adhesion wheel 70 has, by way of example, a carrier wheel 72, on the running surface of which an adhesion structure 74, in particular a gecko structure, is arranged. During operation, the adhesion wheels 70 with the adhesion structure 74 then contact the carrier structure 12 and thus provide an adhesive force by means of which the handling unit 26 is held on the carrier structure 12.

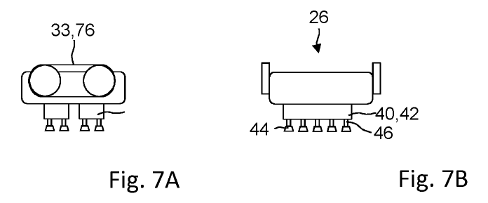

FIG. 7A and 7B show a further exemplary embodiment of a mobile handling unit 26, which has a chain or belt 76 as a running component instead of the magnetic wheels 52. In other respects, however, the mobile handling units 26 according to FIG. 7A and 7B correspond to the handling units 26 explained above with reference to FIG. 1 to 3, and therefore reference is made to the above disclosure to avoid repetition.

The chain 76 can comprise a permanent magnetic material. Alternatively, the chain 76 – similarly to the suction wheels 64 – can have a plurality of suction cups. Alternatively, the chain 76 – similarly to the adhesion wheels 70 – can have a peripheral adhesion structure.

The handling units 26 shown in FIG. 5A to 7B can be used both in the embodiment of the handling system 10 according to FIG. 1 and also according to FIG. 4.

What is claimed is:

1. A handling system, comprising:
a carrier structure, in particular carrier plate, which at least partially delimits a work space,
at least one, preferably more than one, mobile handling unit movable along the carrier structure, in particular in any directions, for clamping and/or gripping an object arranged in the work space,
wherein the mobile handling unit has at least one running component, in particular wheel, with which the mobile handling unit moves along a side of the carrier structure facing the work space, and wherein the mobile handling unit has a drive device for driving the at least one running component;
a holding device for providing a holding force, in particular an attractive force, between the mobile handling unit and the carrier structure.

2. The handling system according to claim 1, wherein the carrier structure delimits the work space at the top in a vertical direction, wherein the at least one mobile handling unit is arranged on an underside of the carrier structure facing the work space and is held against falling by means of a holding force, in particular magnetic force.

3. The handling system according to claim 1, wherein the holding force is a magnetic force, a suction force and/or an adhesive force.

4. The handling system according to claim 1, wherein the holding force is equal to or greater than a weight force of the mobile handling unit.

5. The handling system according to claim 1, wherein the holding device has at least one first holding component and at least one second holding component, wherein the holding force is provided by the interaction of the first holding component with the second holding component, wherein the first holding component is provided on or by the at least one running component, in particular wheel, of the mobile handling unit and the second holding component is provided on or by the carrier structure.

6. The handling system according to claim 1, wherein the running component or at least one of the running components of the mobile handling unit is designed as a traction wheel which adheres to the carrier structure by means of magnetic force, suction force or adhesive force.

7. The handling system according to claim 1, wherein the running component or at least one of the running components, in particular all the running components, of the mobile handling unit comprises a permanent magnetic material and wherein the carrier structure comprises a magnetizable material, in particular steel or vice versa.

8. The handling system according to claim 1, wherein the running component or at least one of the running components, in particular all the running components, of the mobile handling unit is designed as a magnetic traction wheel, wherein the carrier structure is designed as a metal plate, in particular a steel plate, or comprises one.

9. The handling system according to claim 1, wherein the running component or at least one of the running components, in particular all the running components, of the mobile handling unit is designed as a suction wheel comprising a plurality of suction cups.

10. The handling system according to claim 1, wherein the running component or at least one of the running components, in particular all the running components, of the mobile handling unit is designed as an adhesion wheel which has an adhesion structure, in particular a gecko structure, on its running surface.

11. The handling system according to claim 1, wherein the holding device, in particular in addition to a design of the at least one running component as a traction wheel, comprises a suction device, in particular a suction plate or Bernoulli suction device, which is separate from the at least one running component and is designed to suction the carrier structure.

12. The handling system according to claim 2, further comprising a securing device which is arranged on the mobile handling unit and/or on the carrier structure, in particular is activatable as required, and is designed to secure the mobile handling unit against falling, in particular independently of the holding device.

13. The handling system according to claim 1, wherein the carrier structure has:
a ceiling portion that delimits the work space at the top in a vertical direction, in particular extends in a horizontal direction,
and/or
a floor portion that delimits the work space at the bottom in the vertical direction,
and/or
a side portion that delimits the work space in the horizontal direction.

14. The handling system according to claim 13, wherein the carrier structure has:
a ceiling transition portion, in particular extending in a curved manner, which connects the ceiling portion to the side portion,
and/or
a floor transition portion, in particular extending in a curved manner, which connects the floor portion to the side portion.

15. The handling system according to claim 13, wherein the carrier structure, in particular the ceiling portion and/or the floor portion, is designed to be height-adjustable at least in portions.

16. The handling system according to claim 1, wherein the at least one mobile handling unit has a gripping device for gripping the object.

17. The handling system according to claim 16, wherein the at least one mobile handling unit also has a lifting device, in particular a cable pull, scissor lift or telescopic rod, on which the gripping device is mounted.

18. The handling system according to claim 17, wherein the gripping device is designed as a suction gripping device, wherein the at least one mobile handling unit also has an, in particular electrically operated, negative pressure generation device for supplying the suction gripping device with negative pressure.

19. The handling system according to claim 1, wherein the handling system has two or more mobile handling units, wherein the mobile handling units are designed such that they can jointly grip an object.

20. A method for operating a handling system according to claim 1, to handle an object arranged in the work space of the handling system, in particular to transfer the object from a source region to a target region, wherein the handling system has two or more mobile handling units, the method comprising:
moving at least two mobile handling units into a respective gripping position from which the mobile handling units can grip the object;
gripping the object by the mobile handling units so that the object is held on the at least two mobile handling units; and
moving the mobile handling units together, in particular synchronously, in particular to a target region.

21. A computer program product stored with instructions, which when executed cause the handling system according to claim 1 to execute a method for operating the handling system to handle an object arranged in the work space of the handling system, in particular to transfer the object from a source region to a target region, wherein the handling system has two or more mobile handling units, the method comprising:
moving at least two mobile handling units into a respective gripping position from which the mobile handling units can grip the object;
gripping the object by the mobile handling units so that the object is held on the at least two mobile handling units; and
moving the mobile handling units together, in particular synchronously, in particular to a target region.
